(19) United States
(12) Patent Application Publication
(10) Pub. No.: US 2005/0031772 A1
(43) Pub. Date: Feb. 10, 2005

(54) Ginger extract preparation

(76) Inventors: Frauke Gaedcke, Waldesch (DE); Bjorn Feistel, Andernach (DE)

Correspondence Address: Paul Grandinetti;Levy & Grandinetti, Suite 1108, 1725 K Street NW, Washington, DC, 20006-1423, US

(21) Appl. No.: 10/496,885

(22) PCT Filed: Nov. 23, 2002
(86) PCT No.: PCT/EP02/13148

(30) Foreign Application Priority Data
Nov. 26, 2001 (DE) 101 59 077.6

(51) Int. Cl. A23L 1/28

(52) U.S. Cl. 426/655

(57) ABSTRACT

The invention relates to stable ginger extract preparations, characterized by having a content of a native ginger extract and of at least one stabilizing auxiliary agent selected from the group of proton-capturing substances, whereby the chemically stabilizing auxiliary agent preferably belongs to the family of polyvinylpyrrolidones and releases the included pungent agents in solution. Stable ginger extract preparations having large amounts of pharmaceutically relevant pungent agents or essential oils are additionally obtained by carefully carrying out method steps, which are relevant to the production, at a temperature of no greater than 45° C. The inventive preparations remain analytically stable over a long period of time of up to 18 months and longer. The invention also relates to solid galenic dosage forms such as capsules, tablets and dragees all of which containing the stable ginger extract preparations.

The invention relates to ginger extract preparations which fulfil the features of a stable extract preparation over a longer period, that is, over a period of up to 18 months and more, and to a process for their production. The invention also describes stable galenic preparations containing ginger extract preparations, such as capsules, coated tablets and tablets and to their use.

Ginger (Zingiber officinale), the property as a healing and spice plant of which has already been known for centuries, has gained increasingly in importance in recent years in the pharmaceutical industry and in the area of nutritional supplements. Preparations from the rootstock of ginger (rhizome zingiberis), and the drug powder itself and extracts recovered therefrom, are used for the treatment of dyspeptic complaints and the symptoms of travel sickness (see for this the literature summary in Langner, E. et al.: Balance 1, 5-16, October 1997). Commission E of the earlier Federal Board of Health also took account of the number of pharmacological investigations, in that it has published a positive monograph “Zingiberis rhizoma” (Federal Legal Gazette No. 85 of 5.5.1988 and Federal Legal Gazette No. 50 of 13.3.1990). The average daily dose is 2-4 g of drug. The essential oil and in particular the pungent materials (gingerols, shogaols and dehydrogingerdiones) are regarded as the ingredients also responsible for the effectiveness. Commercial preparations which conform to the monograph are currently drug powders and tea blends having a dose of 2-4 g which conforms to the monograph and corresponding extracts which are produced using alcohol/water mixtures. On the other hand, extracts produced using supercritical CO₂ are not covered by the monograph of Commission E because of inadequately verified effectiveness and tolerance. However they are conventional in the foodstuffs industry as spice extracts.

The gingerols form the main proportion in terms of quantity within the pungent materials. Shogaols and dehydrogingerdiones are present in significantly lower quantities, since they represent biogenetically only side-products of gingerols (Schuhbaum, H., Franz, G.: Zeitschrift für Phytotherapie 21, 203-209, 2000).

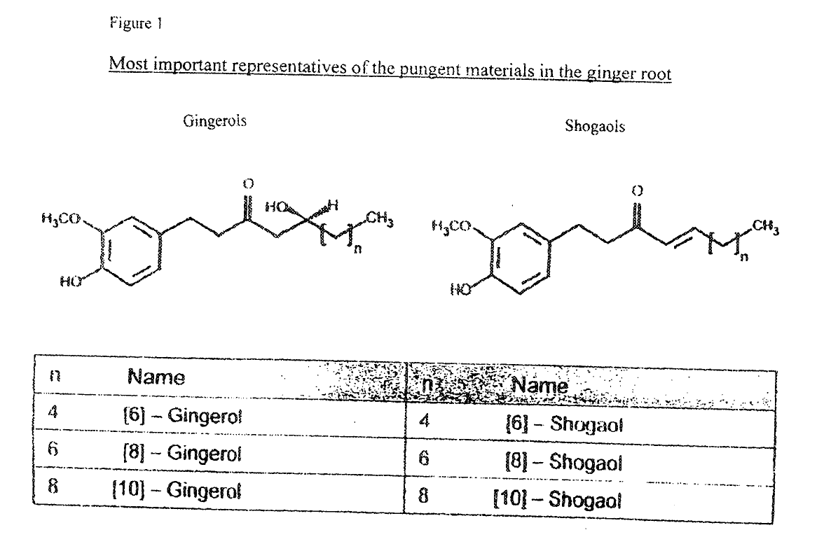

The gingerols have various length side chains (6, 8 and 10 C atoms, see FIG. 1), wherein the [6]-gingerol represents the main component (Falch, B. Reichling, J., Saller, R.: Dtsch. Apotheker Zeitung 137, 47-60). In addition to gingerols, pharmacological effects for the [6]-shogaol are also described (Suekawa, M. et al.: J. Pharm. Dyn. 7, 836-848, 1984).

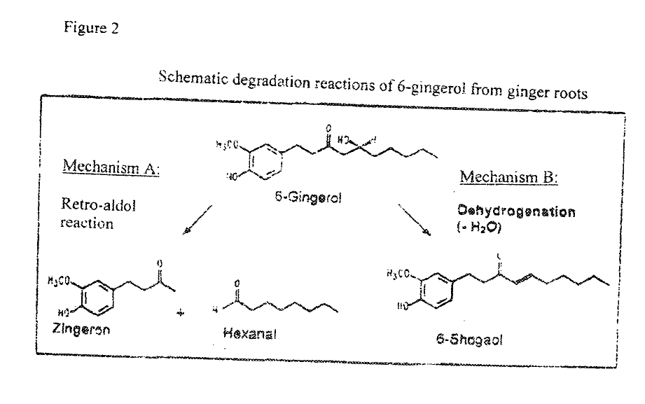

It is known that shogaols are produced from the gingerols during the storage of whole and in particular of comminuted ginger roots (Zhang, X. et al.: J. Food Science, 59, 1338-1343, 1994). Continuous conversion of gingerols to shogaols is also described for powdered ginger roots on storage (Steinegger, E., Stucki, K.: Pharm. Acta. Helv. 57, 3, 1982) see FIG. 2—Mechanism A.

It is also described that the content of gingerols in extracts produced in alcoholic-aqueous manner decreases in favour of the formation of shogaols (Dissertation Germer S., University of Regensburg 1996); see FIG. 2—Mechanism B. The ratio of [6]-gingerol to [6]-shogaol is thus a quality-relevant parameter for assessing the production of ginger extracts and their further processing (Feistel, B., Gaedcke, F. et al.: Analytical characterisation of ginger preparations, Poster No. P19, Finzelberg Symposium 2000).

In order to guarantee a consistent, therapeutic quality of ginger preparations, reproducible quality must be ensured. The basic prerequisite for this is that the conversion of gingerols to shogaols is prevented as much as possible (constant ratio of [6]-gingerol to [6]-shogaol).

It is therefore desirable to provide ginger preparations, in which the known rearrangement reaction of gingerols is avoided and as consistent as possible a gingerol/shogaol ratio is ensured. Those preparations, in which the variations of an ingredient are not more than up to +/−10% over the service life, are regarded as stable in the pharmaceutical sense for pharmaceutically relevant ingredients.

It is known from German Offenlegungsschrift DE 198 59 499 A1 that ginger extracts may be stabilised by addition of at least one galenic auxiliary, so that the pungent material content (here only the sum of the main substance 6-gingerol and its degradation product 6-shogaol) over a period of 18 months decreases by a maximum 10%. Oils, semi-solid triglycerides, fatty acids and fatty alcohols are thus mentioned as auxiliaries. It is possible in this manner that 6-gingerol decreases only by up to 20%, whereas 6-gingerol degrades in a natural ginger extract under the same conditions by about 32%.

The parameter pungent material content (indicated as the sum of 6-gingerol and its degradation product 6-shogaol) thus naturally remains constant (see conversion according to FIG. 2), so that it is not suitable for a statement of quality. Only the ratio of 6-gingerol to 6-shogaol is meaningful here in conjunction with the pungent material content (sum of 6-gingerol, 8-gingerol, and 10-gingerol and 6-shogaol).

The lipophilic auxiliaries mentioned in patent specification German Offenlegungsschrift DE 198 59 499 A1 ensure that the gingerols are stabilised by physical means by increasing the viscosity. However, it is disadvantageous that the galenic auxiliaries used here (oils, fats) are not able to prevent dehydration underlying the loss of stability of the gingerols. This also includes the fact that oily, pasty preparations are produced according to this process which may usually only be placed in soft gelatine capsules, as is known hitherto also for lipophilic ginger spissa or ginger oleosa. Stable, solid galenic forms of administration of oily ginger extracts, such as tablets, capsules or coated tablets are not known hitherto.

One object of the present invention is therefore to provide ginger extract preparations which ensure long-term stability of the gingerols and of the gingerol/shogaol ratio and which furthermore may be processed in simple manner to form various solid, stable forms of administration.

This object is achieved according to the invention by the production of ginger extract preparations, comprising a content of ginger extract, which contain at least one stabilising auxiliary from the group of proton-capturing substances. It has been found, surprisingly, that by adding such substances, the degradation reactions of the gingerols are largely prevented so that ginger extract preparations are obtained which have over many months an essentially stable [6]-gingerol content and a consistent ratio of [6]-gingerol to [6]-shogaol. Protonation of the ginger ingredients, which effects dehydration and hence decomposition of these materials, is thus prevented in that the proton-capturing substance absorbs the free protons present or fends off an attack by free protons present.

The ginger extract preparations of the invention are not oily, as is known from the current preparations. Rather, they are dry, pourable extract preparations which can also be tabletted directly. Furthermore, the temperature susceptibility of the gingerols is greatly reduced with respect to commercial ginger extract preparations. Hence, a stress test of ginger extract preparations of the invention at 40° C. showed no change whatever in the gingerol content (see attached Table).

TABLE 1
Comparative stability of ginger extract preparations over
4 weeks at 40° C. (The particular ratio 6-gingerol to
6-shogaol present as a measure of the stability is indicated
in brackets.)

| | Invention | State of the art |
|---|---|---|
| | Sample 9101.1100 | (DE 19 859 499 A1) |
| Initial value 6-gingerol | 2.29% (2.6:1) | 8.11% (2.0:1) |
| 4 weeks 40° C. | 2.23% (2.6:1) | 6.80% (1.3:1) |

Those auxiliaries from the group of proton-capturing substances, in which the proton-capturing substance is suitable to quantitatively re-release the pungent materials from the extract-auxiliary complex, in which thus the auxiliaries used do not prevent the release of the pharmaceutically relevant ingredients from the form of administration (no formation of irreversible inclusion compounds), are particular preferred. Hence, a consistent pharmaceutical quality may be ensured.

Polyvinylpyrrolidones (Kollidons, polymer N-vinylpyrrolidones) have emerged as particularly preferred auxiliaries for stabilisation from the group of proton-capturing substances, which at the same time guarantee quantitative release of the relevant ingredients.

The use of polyvinylpyrrolidones as auxiliary for the production of galenic forms has been known for many years. They are used as galenic rupturing agents and serve in particular to increase the solubility of medicaments which are difficult to dissolve. Polyvinylpyrrolidones are also used as for plant extracts. Hence, it is known from PCT application WO99/32130 to use polyvinylpyrrolidones in order to improve the release of valuable ingredients of dry extracts of medicinal plants. A semi-solid or solid complex of plant extract and excipient is thus used, in which the valuable extract constituents are present distributed microdispersely so that their release both in degree and in rate can be standardised to a high level. The polyvinylpyrrolidones, cellulose or starch derivatives mentioned in addition to other materials, such as polyethylene glycols, polyvidone acetates and polyvinyl glycols, effect improved water solubility and likewise improved release of the ingredients due to surface area enlargement. As also in other cases, use is thus made of the influence of the polyvinylpyrrolidones on the physical properties of the dry extracts of medicinal plants for the use according to PCT application WO99/32130.

It has been shown, surprisingly, within the framework of the present invention that in the case of ginger extract preparations, polyvinylpyrrolidones furthermore also have chemical influence and act in stabilising manner on the ingredients. In that they act as protein capturers, they prevent protonation and dehydration of the gingerols resulting therefrom. This chemical principle is active during the production process of the ginger extract preparations (in liquid medium) and also during long-term storage (in solid form).

In particular all pharmaceutical auxiliaries having nitrogen compounds belong to the group of proton-capturing substances due to the free electron pair. Substances, such as zeolites or cyclic oligosaccharides, in which the reactions of protons with the gingerols are prevented by formation of an extract-auxiliary inclusion complex, may also act in proton-capturing manner. These auxiliaries have indeed emerged as suitable in terms of quality for stabilisation of ginger extract preparations, but they do not guarantee at the same time the quantitative availability of the ginger pungent materials, such as for example the polyvinylpyrrolidones are able to do.

In particular of the cyclodextrins, for example β-cyclodextrin, it is known that they are able to separate the ginger ingredients to be stabilised spatially from the extract matrix and thus prevent their protonation. This principle is used, for example to mask the pungent ginger taste, for example in chewable tablets (see German Utility Model 20 102 817). However, this inclusion complex is not able to quantitatively re-release the pungent materials subsequently (partial irreversible inclusion complexes). This auxiliary is therefore not suitable for medicinal use of ginger extract preparations.

To ensure stabilisation, the ratio of proton-capturing auxiliary to natural extract is preferably greater than 50%, in particular it lies between 60 and 90%, wherein a value of about 75% has proved to be particularly advantageous.

The processes known hitherto for producing ginger extract preparations have therefore also emerged as disadvantageous, because these pharmaceutically relevant ingredients, such as the pungent materials and the essential oil, are reduced in the resulting extract.

A further object of the present invention is therefore to provide a process for producing stable ginger extract preparations, in which it is furthermore guaranteed that as large as possible a quantity of pharmaceutically relevant substances is transferred into the extract preparation.

This object is achieved according to the invention by a process, in which the process steps are carried out at a temperature of 45° C. maximum. At these gentle temperatures, the processes which lead to a reduction in ginger ingredients, are reduced and hence ginger extract preparations having a significantly increased proportion of pharmaceutically relevant ingredients are obtained. The range between 35 and 45° has emerged as a particularly preferred temperature range, since these temperatures on the one hand are high enough to guarantee an adequate rate for the extraction process, but on the other hand are low enough to ensure gentle process control.

Such gentle process control ensures that the ratio of [6]-gingerol to [6]-shogaol, which, as mentioned in the introduction, is a quality-relevant parameter for assessing the production of ginger extracts and further processing thereof, is significantly higher and more stable that for traditional production processes.

At least one stabilising auxiliary from the group of proton-capturing substances is preferably used in the production process. The use of at least one substance from the group of proton-capturing substances ensures that the decomposition reactions of the ginger ingredients caused by protonation are minimised.

The extraction agents used for the extraction of the ginger rootstock belong preferably to the group of alcohols having C1-C4 carbon atoms, the group of aliphatic ketones having C1-C5 carbon atoms, the group of aliphatic hydrocarbons, the group of aqueous-alcoholic solvent mixtures from 1-99% V/V, the group of solvent mixtures of water and ketones from 1-99% V/V or are pure water or a supercritical gas, such as carbon dioxide.

The primary extraction of rhizome zingiberis using a preferably polar extraction agent mixture ensures, by gentle, exhaustive percolation, as great as possible a yield of pharmaceutically relevant ingredients, such as for example the pungent materials or the essential oil. The drug having a 10 to 12 times excess of solvents is thus used at a temperature of 45° C. maximum. The eluates obtained are combined and gently concentrated under vacuum. The pasty extracts obtained are adjusted to about 20% dry solids using ethanol. The diluted ethanolic solutions are mixed well by stirring at room temperature with the likewise purely ethanolic solutions of stabilising auxiliaries having a dry solids portion of about 10%. Gentle concentration of this mixture then takes place under vacuum at 35-45° C. production temperature. This gentle production guarantees obtaining a pasty extract without reduced content of pungent materials and/or essential oil. The final drying takes place in turn gently in a vacuum-drying cabinet at 35-45° C. with addition of dry auxiliaries, such as for example maltodextrins or of silicon dioxides. A dry, pourable and stable ginger extract preparation is produced.

The process for production preferably comprises the process steps

gentle primary extraction of the comminuted ginger roots,

gentle further concentration, in particular by extraction using supercritical carbon dioxide,

addition of at least one stabilising auxiliary to the liquid extract solution with 20% dry solids,

final gentle evaporation and drying of the extract preparation thus obtained.

Further gentle concentration and drying has the advantage that the resulting ginger extract preparations are a pourable powder which at the same time is virtually free of aflatoxin impurities.

Extraction using supercritical carbon dioxide has thus emerged as a particularly advantageous form of concentration, wherein other processes are also conceivable and possible, such as for example column-chromatography or liquid-liquid processes.

Finally, it is an object of the invention to provide galenic preparations, in which since they contain stable ginger extract preparations, consistent quality may be ensured even over a longer period and for different charges.

This object is achieved by galenic preparations which contain the ginger extract preparations of the invention, wherein the preparations may additionally contain conventional auxiliaries, such as silicon dioxides, maltodextrins, magnesium stearates, celluloses or carboxymethyl starches. Those galenic preparations are preferably provided for processing in any forms of capsules, tablets and coated tablets.

It is possible for the first time due to the invention to obtain a dry, stabilised ginger extract preparation. It can be seen from DE 198 59 499 that an ethanolic-aqueously produced extract, which is transferred into a dry ginger extract preparation by means of adsorbing galenic auxiliaries (silicon dioxide) has a decrease in 6-gingerol by about 37% even after 2 months. Accordingly, it is possible for the first time due to this invention to press ginger extract preparations to form tablets without a loss in stability. Since the stability of ginger extract preparations is furthermore significantly increased by the present invention, a considerably longer service life may also be guaranteed than for non-stabilised, galenic preparations.

The ginger extract preparation of the invention may be used in particular as medicament for the treatment of dyspeptic complaints, of symptoms of travel sickness, as anti-emetic agent, as anti-diabetic agent, as analgesic agent, for pregnancy-related or chemotherapeutically induced vomiting, for arteriosclerosis, for diseases of the rheumatic type or as appropriate nutritional supplements.

Further advantages and embodiments can be seen from the examples and tests described below. Two figures are also attached for illustration, of which FIG. 1 shows the most important representatives of the pungent materials in the ginger root and FIG. 2 shows the degradation reactions using the example of main pungent material compound 6-gingerol.

### COMPARATIVE EXAMPLE 1

Sample A: Non-Stabilised Ginger Spissum Extract (Extract Zingiberis e rhiz. spir. spiss.)

50 kg of rhizome zingiberis, cut and sieved to form part pieces of 6-8 mm, are exhaustively percolated using 500 kg of ethanol 96% [V/V]. The product temperature thus does not exceed 45° C. The filtrated, ethanolic runnings are combined and gently concentrated under vacuum at 45° C. to form pasty extracts.

### EXAMPLE 2

Sample B: Ginger Preparation, Stabilised by Kollidon 25

45.5 g of initial extract—produced like Sample A (extract Zingiberis e rhiz. spir. spiss. with a dry solids content of 33%—corresponds to 15 g of dry extract—are diluted using ethanol >99% to 20% dry solids. Intensive stirring is carried out for 15 minutes—Solution 1.

99.75 g of Kollidon 25 are diluted with stirring using ethanol >99% to 10% dry solids. Intensive stirring is carried out for 30 minutes—Solution 2.

Both solutions are combined in portions with stirring at room temperature, wherein a red-brown, clear solution is produced. Stirring is carried out for 30 minutes and the mixture concentrated on a rotary evaporator gently at 45° C. maximum water bath temperature. The extract preparation obtained is evaporated until free of solvent and dried in a drying cabinet at 45° C. under vacuum. 5% of silicon dioxide is added as auxiliary.

For Samples A and B, in each case the pungent material contents (6-gingerol, 8-gingerol, 10-gingerol and 6-shogaol) were checked using an HPLC process at the start (=start values) and after 11 and 15 months. The data shown in Table 2 below were thus obtained:

TABLE 2
Stability of preparations of the invention compared to the
non-stabilised initial extract A. The pungent material
content of extract preparations B and C was calculated to
be able to compare to the natural extract. (The ratio of
6-gingerol to 6-shogaol as a measure of the degree of
rearrangement which has taken place is indicated in brackets).

| | Analytical | Start | | |
|---|---|---|---|---|
| Sample | parameters | (Start value) | 11 months | 15 months |
| A | Pungent material | 20% | 15.9% | 15.4% |
| | content | | | |
| | Ratio 6-gingerol: | (3.4:1) | (1:1) | (0.7:1) |
| | 6-shogaol | | | |
| B | Pungent material | 15.6% | 15.6% | 15.6% |
| | content | | | |
| | Ratio 6-gingerol: | (1.9:1) | (1.9:1) | (1.9:1) |
| | 6-shogaol | | | |

It is shown that for the non-stabilised extract A, the pungent material content decreases by almost 25% and in particular also the ratio 6-gingerol to 6-shogaol is reversed; on the other hand the stabilised extract preparation B of the invention has a significantly improved stability relating to the pungent material content and in particular a ratio of 6-gingerol to 6-shogaol which is constant within the analytical error tolerance.

Furthermore, stability tests were carried out on samples with different natural extract proportion with the following results (Table 3).

TABLE 3
Stability data of ginger extract preparations with Kollidon
25 as auxiliary (at room temperature)

| 13% natural | | | | | |
|---|---|---|---|---|---|
| extract | | Time [Months] | | | |
| proportion | Start | 6 | 12 | 18 | Changes |
| Pungent | 3.14 | 3.12 | 3.16 | 3.09 | −1.9%* |
| material | | | | | |
| content [%] | | | | | |
| 6-gingerol:6- | 4.9:1 | 4.5:1 | 4.5:1 | 4.6:1 | Constant* |
| shogaol | | | | | |
| 6-gingerol [%] | 1.82 | 1.78 | 1.78 | 1.79 | −1.7%* |
| 6-shogaol [%] | 0.37 | 0.40 | 0.40 | 0.38 | +2.5%* |
| 30% natural | | | | | |
| extract | | Time [Months] | | | |
| proportion | Start | 2 | 8 | 16 | Changes |
| Pungent | 4.34 | 4.29 | 4.19 | 4.18 | −3.7% |
| material | | | | | |
| content [%] | | | | | |
| 6-gingerol:6- | 2.6:1 | 2.6:1 | 2.6:1 | 2.6:1 | stable |
| shogaol | | | | | |
| 6-gingerol [%] | 2.29 | 2.16 | 2.12 | 2.18 | −4.8% |
| 6-shogaol [%] | 0.88 | 0.83 | 0.82 | 0.81 | −8.0% |
| 49% natural | | | | | |
| extract | | Time [Months] | | | |
| proportion | Start | 2 | 8 | 16 | Changes |
| Pungent | 9.00 | 8.80 | 8.77 | 8.74 | −2.9% |
| material | | | | | |
| content [%] | | | | | |
| 6-gingerol:6- | 2.7:1 | 2.8:1 | 2.8:1 | 2.9:1 | stable |
| shogaol | | | | | |
| 6-gingerol [%] | 4.77 | 4.68 | 4.58 | 4.67 | −2.1% |
| 6-shogaol [%] | 1.78 | 1.67 | 1.61 | 1.66 | −6.7% |

*The relative changes of a few contents lie partly within the analytical error range and are therefore marginal.

It is shown that the ginger extract preparations also remain stable over a long period. In contrast, an untreated ginger extract shows the behaviour shown in Table 4:

TABLE 4
Stability data of a non-stabilised ginger extract; monitoring
over 8 weeks was not useful in view of the results.

| | | Time [Weeks] | |
|---|---|---|---|
| Initial extract | Start | 8 | Changes |
| Pungent | 11.2 | 9.0 | - about 20% |
| material | | | |
| content [%] | | | |
| Ratio 6- | 3.1:1 | 0.8:1 | Reverse of the |
| gingerol:6- | | | ratio; |
| shogaol | | | rearrangement |

Stabilised ginger extract preparations with different natural extract proportions were also investigated for their temperature stability over 6 months. The result is shown in Table 5:

TABLE 5
Results of the pungent material content during the stress
test of stabilised ginger extract preparations over 6 months.
(The ratio of 6-gingerol to 6-shogaol as a measure of the
degree of rearrangement which has taken place is
indicated in brackets).

| | Pungent | | | Appear- |
|---|---|---|---|---|
| Sample | material | | | ance |
| designation | content | Ratio 6-gingerol:6-shogaol) | | after |
| Temperature | Start value | 2-week value | 6-month value | 6 months |
| 30% natural | | | | |
| extract | | | | |
| (Spir. Spiss.) | | | | |
| 25° C./60% rF | 4.34 (2.6:1) | 4.26 (2.6:1) | 4.19 (2.6:1) | Powdery |
| 30° C./60% rF | | 4.23 (2.6:1) | 4.17 (2.5:1) | Powdery |
| 40° C./75% rF | | 4.18 (2.4:1) | 4.16 (2.2:1) | Slightly |
| | | | | lumpy |
| 49% natural | | | | |
| extract | | | | |
| (Spir. Spiss.) | | | | |
| 25° C./60% rF | 9.00 (2.7:1) | 8.59 (2.7:1) | 8.70 (2.8:1) | Lumpy |
| 30° C./60% rF | | 8.44 (2.6:1) | 8.61 (2.7:1) | Sintered |
| 40° C./75% rF | | 8.61 (2.7:1) | 8.24 (2.3:1) | Sintered |
| 23% natural | | | | |
| extract | | | | |
| (Oleosum*) | | | | |
| 25° C./60% rF | 4.90 (6.1:1) | 4.94 (5.9:1) | 4.94 (5.8:1) | Powdery |
| 30° C./60% rF | | 4.95 (5.8:1) | 5.05 (5.7:1) | Powdery |
| 40° C./75% rF | | 4.81 (5.6:1) | 4.91 (4.6:1) | Slightly |
| | | | | lumpy |

*produced by extraction using supercritical carbon dioxide

Stability changes within a span of +/−5% to +/−10% are regarded as stable in the pharmaceutical sense for pharmaceutically relevant ingredients. Independently of the actual test at elevated temperature and moisture according to ICH guidelines, it has been established that even visually, the preparation having increased natural extract proportion of 49% tends to form lumps. This impression was further reinforced by the temperature increase. This extract preparation is therefore not suitable for examination of the long-term stress test. The content of pungent materials remained within the +/−5% limit for the two other ginger extract preparations, even at elevated temperatures, up to the 6-month value. Successful stabilisation is thus proved.

The thermal stability of an untreated extract and a stabilised ginger extract preparation is shown in Table 6 below:

TABLE 6
Test of thermal stability over 24 hours (untreated versus
stabilised extract)

| | | Ginger extract preparation |
|---|---|---|
| | | stabilised with Kollidon 25 |
| | | Natural extract proportion |
| | Extract Zingiberis e rhiz. spir. | 10.5% |
| Temper- | spiss. | (Details calculated on natural |
| atures | Natural extract, not stabilised | extract proportion) |
| | Sum 6, 8 and 10 gingerol | Sum 6, 8 and 10 gingerol |
| Room | 13.3% | 13.3% |
| temper- | | |
| ature | | |
| 40° C. | 13.2% | 13.2% |
| 50° C. | 13.2% | 13.2% |
| 60° C. | 12.3% | 13.1% |
| 70° C. | 11.5% | 12.2% |
| | Ratio 6-gingerol/6-shogaol | Ratio 6-gingerol/6-shogaol |
| Room | 1.7:1 | 1.7:1 |
| temper- | | |
| ature | | |
| 40° C. | 1.7:1 | 1.7:1 |
| 50° C. | 1.6:1 | 1.6:1 |
| 60° C. | 1.4:1 | 1.6:1 |
| 70° C. | 1.2:1 | 1.4:1 |

The results show that the stabilised extract preparation, even at elevated temperatures, has significantly improved stability properties compared to hitherto conventional, non-stabilised ginger extracts. This is verified by a lower tendency to degrade the gingerols and by a lower decrease in the 6-gingerol/6-shogaol ratio. Temperatures up to 40-50° C. accordingly prove to be unproblematic. Even the simultaneously tested, unstabilised ginger soft extract withstood the short-term stress in this temperature range, so that the maximum temperature stress for gentle primary extraction of about 45° C. could be derived. Known extraction temperatures for ginger roots range from room temperature to 90° C, wherein up to the last value, no impairments of quality are described for the extract (Govindarajan, V. S.: Crit. Rev. Food. Sci. Nutr. 17, 189-258, 1982). However, the newly obtained findings prove that the extraction conditions of >50° C. conventional hitherto in industry therefore lead to losses of pungent materials and hence to pharmaceutically low-grade extract even during primary extraction of the ginger roots.

As the test results as a whole show, the extract preparations of the invention remain stable over a long period of up to 18 months and more. Surprisingly, they are also thermally significantly more stable than untreated extracts. A temperature limiting value of 45° C. maximum could be determined for gentle process control in the production of ginger extracts, in particular for primary extraction which still proceeds without the addition of a stabilising auxiliary. It thus runs gently and exhaustively (high yield of pharmaceutically relevant ingredients). It is also preferable for further process control for producing the ginger extract preparation to use temperatures of 45° C. maximum according to the invention, since the decomposition or the decrease in pharmaceutically relevant substances may thus be reduced.

Extraction using supercritical carbon dioxide is equally gentle-temperature processing. A combination of an ethanolically/aqueously produced primary extract (thick extract) and its downstream extraction using supercritical carbon dioxide leads to a ginger extract which is very highly enriched in pungent materials and essential oil. At the same time, co-extracted extract constituents which are not relevant to effectiveness are largely removed and further depleted.

The yield of these coupled process steps primary extraction and CO₂ extraction lies at only about 2-3% based on the drug quantity used, corresponding to a DER natural (Drug Extract Ratio) of about 33-50:1. On the other hand, a conventional, direct CO₂ extraction of rhizome zingiberis leads to a yield of about 4%, corresponding to a DER natural of about 25:1.

The addition of a proton-capturing substance leads to a highly proportioned, stabilised ginger extract preparation with this highly enriched extract, which compared to single extraction using organic solvents and direct CO₂ extraction, is a pharmaceutically completely novel material.

### EXAMPLE 3

Ginger spissum extract, produced analogously as described in Comparative example 1, contains 15.8% total pungent materials and 15.1% essential oil (DER natural 12:1). Of this, 10.0 kg spissum extract are absorbed onto 10.0 kg of kieselguhr and extracted using a CO₂ throughput of 10 kg/kg of mixture. The anhydrous yield of oily ginger extract is 34% based on the use extract. The resulting ginger oleosum contains 22.7% of total pungent materials and 39.0% of essential oil (DER natural 35:1).

15 g of ginger oleosum are diluted using ethanol >99% to 20% dry solids. Stirring is carried out for 30 minutes until a homogeneous solution is obtained—Solution 1. 85 g of Kollidon 25 are diluted with stirring using ethanol >99% to 10% dry solids. Intensive stirring is carried out for 30 minutes—Solution 2.

Both solutions are combined in portions with stirring at room temperature, wherein a red-brown, clear solution is produced. Stirring is carried out for 30 minutes and the mixture is gently concentrated on a rotary evaporator at 45° C. maximum water bath temperature. The ginger extract preparation obtained is evaporated until free of solvent and dried in a drying cabinet at 45° C. under vacuum. A pale yellow, pourable powder having about 3% pungent materials is obtained.

### EXAMPLE 4

A stabilised ginger extract preparation according to Example 2, containing 28% of natural ginger extract, 63% of Kollidon 25 and 9% of highly dispersed silicon dioxide is produced. The solid form of a stabilised ginger extract preparation produced according to the invention is pressed in a coated tablet.

Recipe of a ginger coated tablet core:

| | |
|---|---|
| Ginger extract preparation | 303.57 mg |
| Sodium dodecyl sulphate | 8.80 mg |
| Maltodextrin | 79.23 mg |
| Silicon dioxide | 8.80 mg |
| Cellulose powder | 11.00 mg |
| Na carboxymethyl starch | 22.00 mg |
| Stearic acid | 6.60 mg |
| Na crosscarmelose | 13.00 mg |

Table 7 gives information on the stability of ginger extract preparations and coated tablet cores produced therefrom.

TABLE 7
Comparative stability of ginger extract preparations and coated
tablet cores over 6 months at 25° C. (The particular ratio of
6-gingerol to 6-shogaol present as a measure of the stability is
indicated in brackets).

| Sample designation | Analytical parameters | Start value | 6 months |
|---|---|---|---|
| Ginger extract | Pungent material | 7.12% | 7.18% |
| preparation used | content | | |
| | Ratio 6-gingerol:6- | (6.9:1) | (7.0:1) |
| | shogaol | | |
| Ginger coated tablet | Pungent material | 4.82% | 4.74% |
| (67% ginger | content | | |
| preparation) | Ratio 6-gingerol:6- | (6.9:1) | (6.9:1) |
| | shogaol | | |

The extract preparation of the invention provides for ginger for the first time a highly proportioned stable phytopharmacological agent, which also guarantees a consistent therapeutic quality in the solid galenic form.

1. Stable ginger extract preparation, characterised by a content of a ginger extract and at least one stabilising auxiliary from the group of proton-capturing substances.

2. Stable ginger extract preparation according to claim 1, characterised in that it is a dry extract preparation.

3. Stable ginger extract preparation according to claim 1 or 2, characterised in that the pungent material content and the ratio of [6]-gingerol to [6]-shogaol remain stable.

4. Stable ginger extract preparation according to one of claims 1 to 3, characterised in that the proton-capturing substance is suitable to quantitatively re-release the pungent materials from the extract-auxiliary complex.

5. Stable ginger extract preparation according to one of claims 1 to 4, characterised in that the stabilising auxiliary from the group of proton-capturing substances belongs to the series of polyvinylpyrrolidones.

6. Stable ginger extract preparation according to one of claims 1 to 5, characterised in that the ratio of auxiliary to natural extract is greater than 50% [m/m].

7. Stable ginger extract preparation according to claim 6, in which the ratio auxiliary to natural extract is 60-90%, but preferably 75% [m/m].

8. Stable ginger extract preparation according to one of claims 1 to 7, containing
at least 1% pungent materials, preferably 3-12% pungent materials
a ratio of [6]-gingerol to [6]-shogaol of at least 2:1, preferably between 3:1 and 8:1
at least 1% essential oil, preferably 5-15% [V/m]
low in aflatoxin corresponding to the conditions of the current aflatoxin prohibition order.

9. Process for producing a stable ginger extract preparation according to one of claims 1 to 8, characterised in that the process steps are carried out at a temperature of 45° C. maximum.

10. Process according to claim 9, characterised in that the process steps are preferably carried out at a temperature between 35 and 40° C.

11. Process for producing a stabilised ginger extract preparation according to one of claims 8 to 10, characterised in that during production, at least one stabilising auxiliary from the group of proton-capturing substances is used.

12. Process for producing a stabilised ginger extract preparation according to one of claims 8 to 11, characterised in that the extraction agents used for extraction of the ginger rootstock originate from the group of alcohols having C1-C4 carbon atoms, from the group of aliphatic ketones having C1-C5 carbon atoms, from the group of aliphatic hydrocarbons, from the group of aqueous-alcoholic solvent mixtures from 1-99% [V/V], from the group of solvent mixtures of water and ketones from 1-99% [V/V] or are pure water or a supercritical gas, such as carbon dioxide.

13. Process according to one of claims 8 to 12, comprising the steps:
gentle primary extraction of the comminuted ginger roots,
gentle further concentration, in particular by extraction using supercritical carbon dioxide,
addition of at least one solution of a stabilising auxiliary to the liquid extract solution with 20% dry solids,
final gentle evaporation and drying of the extract preparation thus obtained.

14. Galenic preparation containing a stabilised ginger extract preparation according to one of claims 1-13 and further commercial auxiliaries, such as silicon dioxide maltoaltodextrins, magnesium stearates, cellulose or carboxymethyl starches.

15. Galenic preparation according to claim 14, present in any form of capsules, tablets and coated tablets.

16. Use of a stabilised ginger extract preparation according to one of claims 1 to 8, of a galenic preparation according to claim 14 to 15 or obtainable according to one of claims 9 to 13 for the treatment of dyspeptic complaints, of symptoms of travel sickness, as anti-emetic agent, as anti-diabetic agent, as analgesic agent, for pregnancy-related or chemotherapeutically induced vomiting, for the treatment of diseases of the rheumatic type or as nutritional supplements.
